(19) United States
(12) Patent Application Publication
(10) Pub. No.: US 2025/0010448 A1
(43) Pub. Date: Jan. 9, 2025

(54) Systems and Methods for Wirelessly Enabling Alternate Power in a Power Tool

(71) Applicant: Milwaukee Electric Tool Corporation, Brookfield, WI (US)

(72) Inventors: Anthony M. Davis, Brookfield, WI (US); Alexander T. Huber, Menomonee Falls, WI (US); Melissa Groenewold, Wauwatosa, WI (US); Johnny Lienau, Glendale, WI (US)

(21) Appl. No.: 18/690,253

(22) PCT Filed: Sep. 9, 2022
(86) PCT No.: PCT/US2022/043122

§ 371 Date: Mar. 7, 2024

Related U.S. Application Data
(60) Provisional application No. 63/242,745, filed on Sep. 10, 2021.
(60) Provisional application No. 63/285,270, filed on Dec. 2, 2021.

(51) Int. Cl. B25F 5/00; H02J 7/00

(52) U.S. Cl. CPC B25F 5/00; H02J 7/00034

(57) ABSTRACT

A system and method for or wirelessly securing a tool in a low power mode is provided. In some embodiments, a system comprises a power source interface configured to selectively receive a battery pack; an alternate power source; a controller electrically coupled to the power source interface, and electrically coupled to the alternate power source via a switch; and a communication system electrically coupled to the alternate power source and the power source interface, and operatively coupled to the switch, wherein the communication system comprises a wireless transceiver and a processor, wherein the processor is configured to: establish a wireless connection with an external device; receive a signal from the external device; and in response to the signal, cause the switch to complete a circuit between the alternate power source and the controller.

### RELATED APPLICATIONS

The present application is based on and claims priority from U.S. Patent Application No. 63/242,745, filed on Sep. 10, 2021, and from U.S. Patent Application No. 63/285,270, filed on Dec. 2, 2021, the entire disclosures of each of which are incorporated herein by reference.

### BACKGROUND

Handheld battery-powered tools, such as drills, cutting tools, sanders, etc., can provide flexibility and convenience for operators. For example, a battery-powered tool can be moved around a job site without extension cords.

### SUMMARY

In accordance with some embodiments of the disclosed subject matter, a system for wirelessly securing a power tool is provided, the system including: a power source interface configured to selectively receive a battery pack: an alternate power source: a controller electrically coupled to the power source interface, and electrically coupled to the alternate power source via a switch; and a communication system electrically coupled to the alternate power source and the power source interface, and operatively coupled to the switch, wherein the communication system comprises a wireless transceiver and a processor, wherein the processor is configured to: establish a wireless connection with an external device: receive a signal from the external device; and in response to the signal, cause the switch to complete a circuit between the alternate power source and the controller.

In accordance with some embodiments of the disclosed subject matter, a method for wirelessly securing a power tool is provided, the method including: establishing, via a communication system, a wireless connection with an external device: receiving a signal from the external device; and in response to the signal, causing a switch to complete a circuit between an alternate power source and a controller, wherein the controller is electrically coupled to a power source interface configured to selectively receive a battery pack, and electrically coupled to the alternate power source via the switch.

In accordance with some embodiments of the disclosed subject matter, a system for wirelessly securing a power tool is provided. The system including: a power source interface configured to selectively receive a battery pack: an alternate power source: a controller electrically coupled to the power source interface, and electrically coupled to the alternate power source via a switch; and a communication system electrically coupled to the alternate power source and the power source interface, and operatively coupled to the switch, wherein the communication system comprises a wireless transceiver and a processor. The processor is configured to stablish a wireless connection with an external device: receive a signal from the external device; and in response to the signal, cause the switch to complete a circuit between the alternate power source and the controller.

In accordance with some embodiments of the disclosed subject matter, a method for wirelessly enabling alternate power in a power tool is provided. The method including: receiving a stimulus at a wake-up sensor: issuing a wake-up signal from the wake-up sensor to a communication system in response to the stimulus: awakening, by the communication system, from a low power state in response to the wake-up signal: controlling, by the communication system in response to the wake-up signal, a switch to complete a circuit between an alternate power source and a controller, wherein the controller is electrically coupled to a power source interface configured to selectively receive a battery pack, and electrically coupled to the alternate power source via the switch: establishing, via the communication system, a wireless connection with an external device: receiving, by the controller, an unlock instruction from the external device via the communication system and the wireless connection; and in response to the unlock instruction, unlocking the power tool.

### BRIEF DESCRIPTION OF THE DRAWINGS

The accompanying drawings, which are incorporated in and form a part of this specification, illustrate embodiments of the disclosure and, together with the description, serve to explain principles of the embodiments:

FIG. 1 is a schematic illustration of a system for wirelessly securing a tool in a low power mode in accordance with some embodiments of the disclosed subject matter.

FIG. 2A is a schematic illustration of a tool implemented with a wireless communication system in accordance with some embodiments of the disclosed subject matter.

FIG. 2B is a schematic illustration of a wireless communication system in accordance with some embodiments of the disclosed subject matter.

FIG. 3 is a schematic illustration of a computing device implemented with a wireless communication system in accordance with some embodiments of the disclosed subject matter.

FIG. 4A is a schematic illustration of connections among a main power source, an alternate power source, a communication system, and a controller of a tool in accordance with some embodiments of the disclosed subject matter.

FIG. 4B is another schematic illustration of connections among a main power source, an alternate power source, a communication system, and a controller of a tool in accordance with some embodiments of the disclosed subject matter.

FIG. 5 is a flowchart of a process for wirelessly enabling alternate power in a power tool in accordance with some embodiments of the disclosed subject matter.

FIG. 6 is a flowchart of a process for wirelessly unlocking a power tool via a wake-up sensor in accordance with some embodiments of the disclosed subject matter.

### DETAILED DESCRIPTION

As described above, battery-powered tools can provide flexibility and convenience. For example, an operator can carry the tool from one area to another without finding a new outlet to use, or moving an extension cord. Additionally, such battery-powered tools can be operated when wall power is not available.

Increased computing capabilities can be incorporated into devices, such as power tools, that can facilitate additional functionality. For example, a communication system can be incorporated into (and/or interfaced with) a power tool, which can facilitate tracking and/or locating the device (e.g., via a beacon functionality). As another example, a communication system can facilitate updating and/or changing parameters and/or modes of a power tool. As yet another example, a communication system can facilitate security features, such as locking the power tool to inhibit or enable its use during certain periods of time. However, such additional functionality generally requires a power source to power the communication system and/or controller to implement such functions. If a main battery is removed from a battery-powered tool, or the main battery lacks power (e.g., the battery lacks sufficient charge), such additional features may be unusable.

As described below, an alternate power source, such as a coin cell battery, can be used to provide power to the communication system (e.g., when power is not available from a main power source), which can facilitate certain additional functionality, such as location and/or tracking when main power is not available. However, it may not be desirable to provide power to a tool controller from the alternate power source, as this may cause the alternate power source to be exhausted more quickly. While limiting the alternate power source to use by the communication system may extend the life of the alternate power source, it can limit certain functionality that may be desirable while only the alternate power source is available. For example, it may be inconvenient and/or difficult to attach a battery pack to a tool to facilitate changing a security state of the tool.

In accordance with some embodiments of the disclosed subject matter, mechanisms described herein can provide solutions to these problems by providing improved systems and methods wirelessly securing a tool in a low power mode.

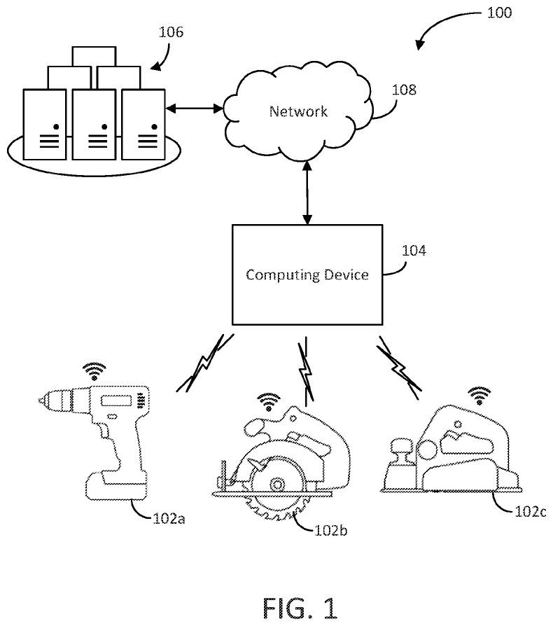

FIG. 1 is a schematic illustration of a system 100 in accordance with some embodiments of the disclosed subject matter. As shown in FIG. 1, system 100 can include various power tool devices 102a, 102b, and 102c, a computing device 104 (sometimes referred to herein as an external device), and one or more remote computing devices 106 (e.g., servers). The power tool devices 102a, 102b, and 102c may each be referred to as a power tool device 102 (or power tool 102), and may be collectively referred to as power tool devices 102 (or power tools 102). The power tools 102 may each be a motorized power tool or a non-motorized power tool. In some cases, each motorized power tool can include a moveable component (e.g., drill bit, driver bit, saw blade, crimper head, cutter head, etc.) and an actuator that can move (e.g., translate, rotate, etc.) the moveable component to implement a functionally on a workpiece. For example, a motorized power tool can be a drill, an impact driver, a crimper, a cutter, etc. In some configurations, each non-motorized power tool can lack an actuator, a moveable component, etc., and thus can lack the ability to implement a functionality on a workpiece. For example, a non-motorized power tool can be a radio, a speaker, work light, a power supply (e.g., a portable power supply), a ruggedized tracking device, a laser level, a laser distance measurer, a battery pack charger, etc.

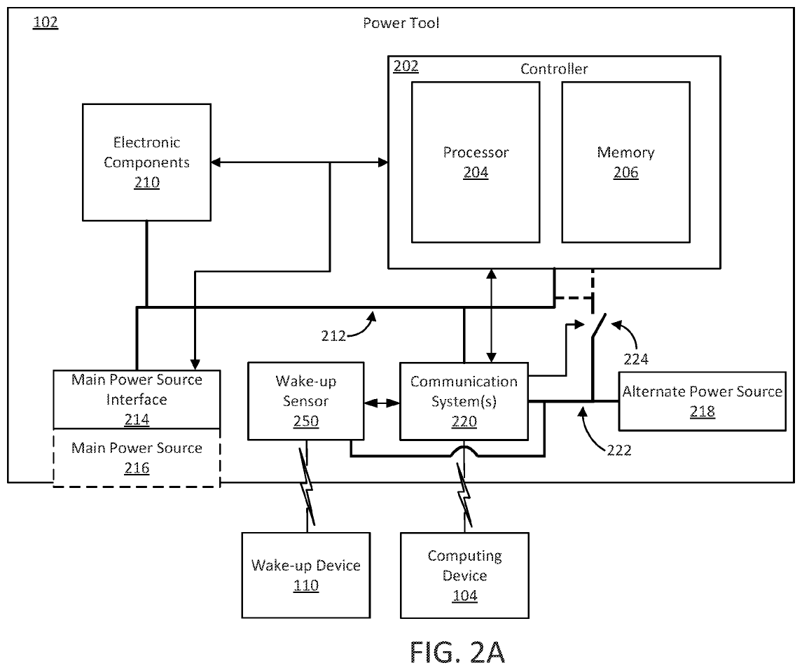

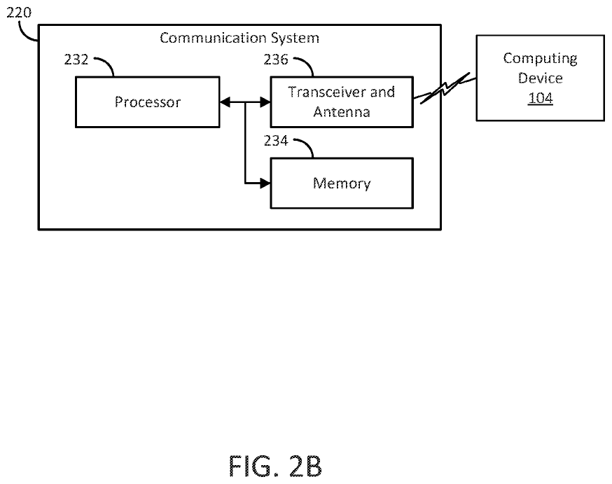

In some embodiments, computing device 104 can wirelessly communicate with one or more power tools 102 using any suitable wireless communication technique or combination of techniques (e.g., as described below in connection with FIGS. 2A-B and 3). In some embodiments, computing device 104 can communicate any suitable information and/or instructions to a particular power tool, such as instructions to alter a security setting of the power tool, instructions to provide data stored by the power tool, information used to update one or more settings and/or parameters of the power tool, instructions to adjust one or more parameters (e.g., operational parameters, safety parameters, tool mode, etc.), etc. In some embodiments, power tool 102 can communicate any suitable information and/or instructions to computing device 104, such as status information (e.g., including a security status), operation data (e.g., operation statistics), identification information associated with the power tool, power tool usage information, power tool maintenance data, etc. As described below in connection with FIGS. 2A to 5, in some embodiments, power tool 102 can be inhibited from communicating certain types of information and/or performing certain types of actions when a main power source (e.g., a battery pack) is not providing sufficient power to the power tool (e.g., because the main power source is not connected, because the main power source is depleted, etc.).

In some embodiments, power tool 102 and/or computing device 104 can communicate with server 106 over a communication network 108. For example, power tool 102 and/or computing device 104 can communicate information to server 106 and/or receive information from server 106. In a more particular example, power tool 102 and/or computing device 104 can communicate status information (e.g., including a security status) associated with power tool 102, operation data (e.g., operation statistics) associated with power tool 102, identification information associated with power tool 102, power tool usage information associated with power tool 102, power tool maintenance data associated with power tool 102, etc. As another example, server 106 can provide information that can facilitate additionally functionality and/or services associated with power tool 102 (e.g., enabling one or more features and/or services), can provide updated software (e.g., an updated application to computing device 104, updated software and/or firmware for power tool 102, etc.), and/or any other suitable functions.

In some embodiments, computing device 104 and/or server 106 can be any suitable computing device or combination of devices, such as a desktop computer, a laptop computer, a smartphone, a tablet computer, a wearable computer, a server computer, a virtual machine being executed by a physical computing device, etc.

In some embodiments, communication network 108 can be any suitable communication network or combination of communication networks. For example, communication network 108 can include a Wi-Fi network (which can include one or more wireless routers, one or more switches, etc.), a peer-to-peer network (e.g., a Bluetooth network), a cellular network (e.g., a 3G network, a 4G network, a 5G network, etc., complying with any suitable standard, such as CDMA, GSM, LTE, LTE Advanced, NR, etc.), a wired network, etc. In some embodiments, communication network 108 can be a local area network, a wide area network, a public network (e.g., the Internet), a private or semi-private network (e.g., a corporate or university intranet), any other suitable type of network, or any suitable combination of networks. Communications links shown in FIG. 1 can each be any suitable communications link or combination of communications links, such as wired links, fiber optic links, Wi-Fi links, Bluetooth links, cellular links, etc.

FIG. 2A is a schematic illustration of a power tool 102 implemented with a wireless communication system in accordance with some embodiments of the disclosed subject matter. As shown in FIG. 2A, power tool 102 can include a controller 202, which can include a processor 204 and memory 206, electronic components 210, a power line 212, a main power source interface 214, a main power source 216, an alternate power source 218, a communication system(s) 220, a second power line 222, and at least one switch 224.

In some embodiments, controller 202 can be a microcontroller, a system on a chip (SOC), a printed circuit board including at least a processor and memory, etc. In some embodiments, processor 204 can be any suitable hardware processor or combination of processors, such as a central processing unit (CPU), a graphics processing unit (GPU), an application specific integrated circuit (ASIC), a field programmable gate array (FPGA), etc.

In some embodiments, memory 206 can include any suitable storage device or devices that can be used to store instructions, values, etc., that can be used, for example, by processor 204 to control components of power tool 102, to communicate with one or more computing devices 104, etc. Memory 206 can include any suitable volatile memory, non-volatile memory, storage, or any suitable combination thereof. For example, memory 206 can include random access memory (RAM), read-only memory (ROM), electrically erasable programmable read-only memory (EEPROM), one or more flash drives, etc. In some embodiments, memory 206 can have encoded thereon a program for controlling operation of controller 202 and/or power tool 102. In such embodiments, processor 204 can execute at least a portion of the program to establish a wireless communication link with a computing device (e.g., computing device 104 via communication system 220), provide power to electronic components 210, receive data and/or content from server 106, transmit data and/or other information to server 106, change one or more settings and/or parameters associated with power tool 102, etc.

In some embodiments, electronic components 210 can include any suitable components, such as one or more switches (e.g., for initiating and ceasing operation of the tool), one or more sensors, one or more motors, one or more indicators, etc. For example, in a motorized power tool (e.g., drill-driver, saw; etc.), the electronic components 210 can include, for example, an inverter bridge, a motor (e.g., brushed or brushless) for driving a tool implement, etc. For a non-motorized power tool (e.g., a work light, a work radio, ruggedized tracking device, etc.), the electronic components 210 can include, for example, one or more of a lighting element (e.g., an LED, a laser, etc.), an audio element (e.g., a speaker), a sensor (e.g., a light sensor, ultrasound sensor, etc.), a power source, charging circuitry, power conversion circuitry, etc. In some embodiments, the controller 202 is configured to control one or more of the electronic components 210. For example, in instances where the electronic components 210 include a motor and a sensor for sensing actuation of a trigger of the power tool 102, the controller 202 may be configured to control an inverter bridge or otherwise control driving of the motor based on sensed actuation of the trigger.

In some embodiments, main power source interface 214 can be configured to selectively receive main power source 216. For example, main power source interface 214 can mechanically receive and/or couple main power source 216 to secure main power source 216 to power tool 102. In some embodiments, main power source interface 214 can also electrically couple main power source 216 to one or more components of power tool 102 (e.g., controller 202, electronic components 210, etc.) to provide power and/or communications between main power source 216 and one or more other components of power tool 102. In some embodiments, power can be provided from main power source 216 via power line 212 (e.g., a wire(s), multiple wires, a bus, a trace, etc.). In some embodiments, main power source interface 214 can include, and/or be associated with, any suitable components configured to regulate and/or control power received from main power source 216 and provided to other components of power tool 102.

In some embodiments, the main power source 216 is a power tool battery pack. A power tool battery pack can include one or more battery cells of various chemistries, such as lithium-ion (Li-Ion), nickel cadmium (Ni-Cad), etc. A power tool battery pack can further selectively latch and unlatch (e.g., with a spring-biased latching mechanism) to the power tool 102 to prevent unintentional detachment. A power tool battery pack can further include a pack electronic controller (pack controller) including a processor and a memory. The pack controller can be configured similarly to the electronic controller 202 of the power tool 102. The pack controller can be configured to regulate charging and discharging of the battery cells, and/or to communicate with the electronic controller 202. The power tool battery pack 244 can further include, for example, a charge level fuel gauge, analog front ends, sensors, etc.

In some embodiments, communication system(s) 220 can include any suitable hardware, firmware, and/or software for communicating information with the computing device 104, over communication network 108, and/or any other suitable communication networks. For example, communication system(s) 220 can include one or more transceivers, one or more communication chips and/or chip sets, one or more antennas, etc. In a more particular example, communication systems 220 can include hardware, firmware and/or software that can be used to establish a Wi-Fi connection, a Bluetooth connection, a near field communication (NFC) connection, a radio frequency identification (RFID) connection, a cellular connection, an Ethernet connection, an ultra wideband (UWB) connection, etc.

In some embodiments, alternate power source 218 can be any suitable alternate power source, such as a relatively small battery, such as a coin cell battery (sometimes referred to as a button cell, or watch battery). Accordingly, in some embodiments, the alternate power source 218 has one or more of a lower maximum voltage, lower nominal voltage, lower maximum current, lower nominal current, and/or lower capacity than the main power source 216. Additionally, the alternate power source 218 may also be physically smaller than the main power source 216. For example, the weight of and/or the physical volume occupied by the alternate power source 218 may be less than the weight of and/or the physical volume occupied by the main power source 216. In some embodiments, power can be provided to communication system(s) 220 from main power source 216 via power line 212 and/or alternate power source 218 via power line 222. For example, when main power source 216 is connected and capable of supplying power via main power source interface 214, communication system(s) 220 can receive power from main power source 216. As another example, when a main power source is not connected and/or not capable of supplying power via main power source interface 214, communication system(s) 220 can receive power from alternate power source 218.

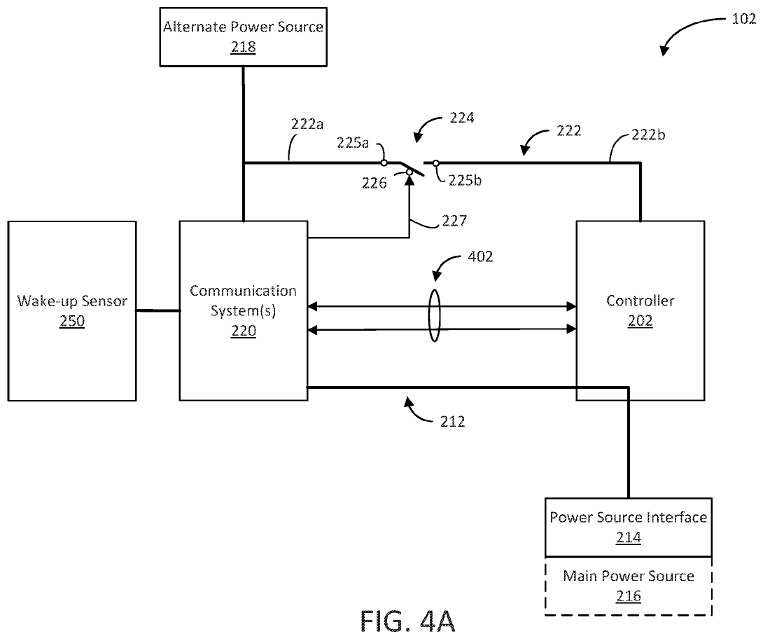

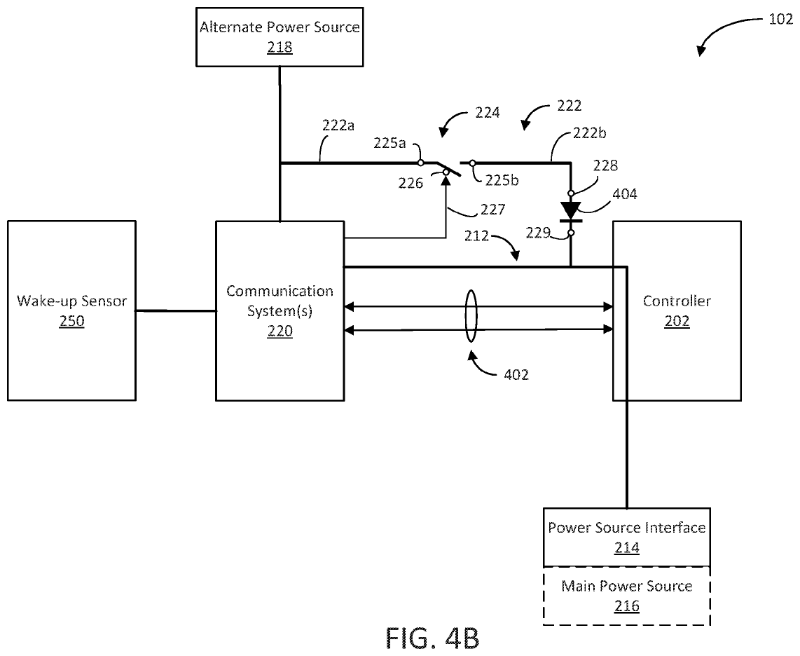

In some embodiments, communication system 220 can control switch 224 to selectively provide power from alternate power source 218 to controller 202. For example, when a main power source is not connected and/or not capable of supplying power via main power source interface 214, communication system(s) 220 can control switch 224 to provide an electrical connection between alternate power source 218 and controller 202. As described below in connection with FIGS. 4A and 4B, power line 222 and switch 224 can provide power to controller 202 via a separate power line, or can provide power to power line 212 (e.g., via a diode that inhibits power from main power source 216 being provided to alternate power source).

In some embodiments, switch 224 can be implemented using any suitable component or combination of components. For example, switch 224 can be implemented using a transistor (e.g., a field effect transistor), a relay (e.g., operated via a solenoid), etc.

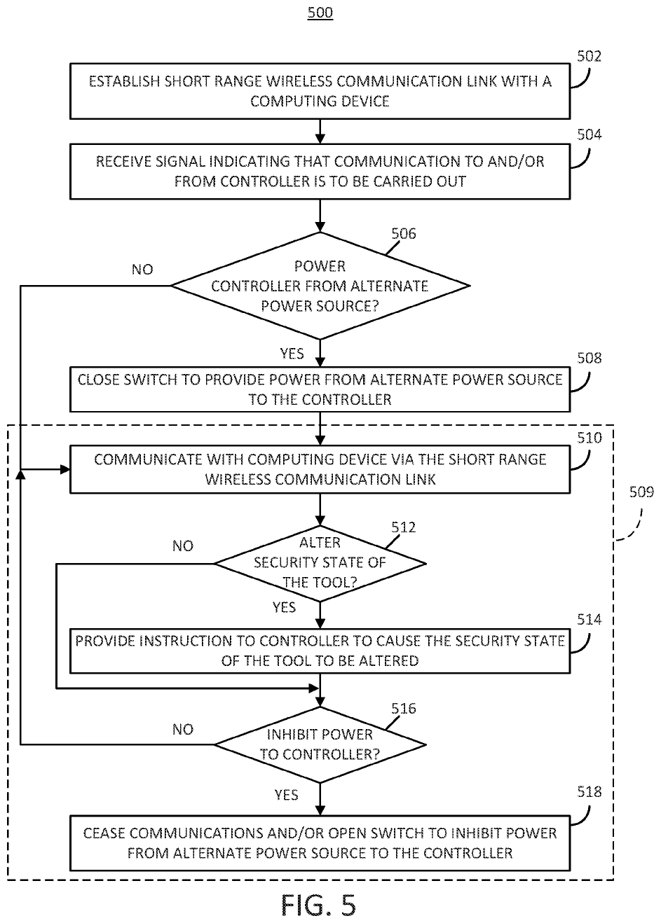

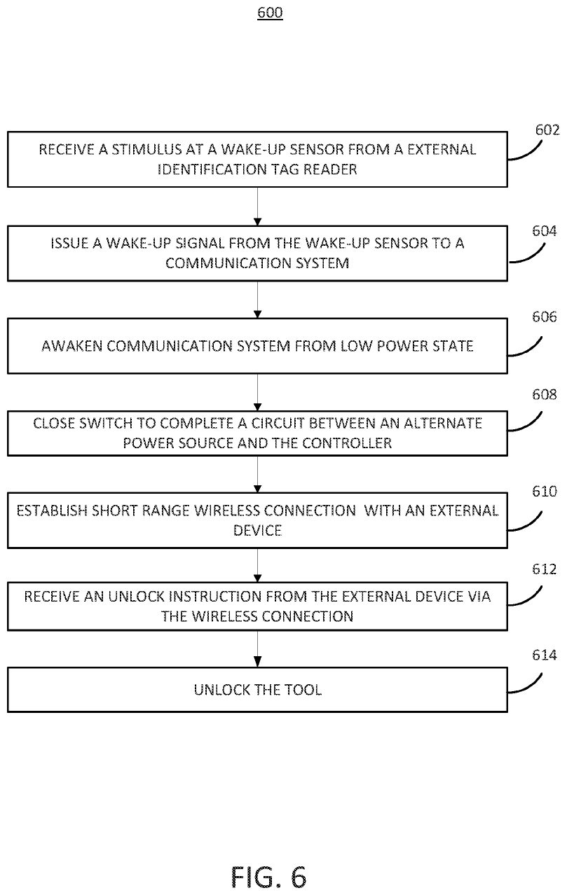

In some embodiments, the power tool 102 further includes a wake-up sensor 250. For example, embodiments of the power tool 102 that may be used to implement the method illustrated in FIG. 6 may include the wake-up sensor 250. In other embodiments, the power tool 102 may not include the wake-up sensor 250, or may optionally include the wake-up sensor 250. For example, embodiments of the power tool 102 that may be used to implement the method illustrated in FIG. 5 may be provided without the wake-up sensor 250, or may optionally include the wake-up sensor 250. In some embodiments, the power tool 102 is configured to implement the processes of both FIGS. 5 and 6, and the wake-up sensor 250 is included in the power tool 102.

In some embodiments, the wake-up sensor 250 may be any suitable sensor configured to receive a stimulus from a wake-up device. For example, the wake-up sensor 250 may include an RFID tag or an NFC tag, and the stimulus could include an electromagnetic signal from the external wake-up device 110 that induces an electrical current in the sensor 250. In some embodiments the stimulus from the wake-up device 110 to the wake-up sensor 250 is an out-of-band communication with respect to the communication between the wireless communication system 220 and the computing device 104. In some embodiments, the wake-up sensor 250) can be electrically coupled to the communication system 220 and can issue a wake signal to the communication system 220 to awaken communication system 220 from a low power state. In particular, the wake-up sensor 250 could issue the wake signal to communication system 220 upon receiving the stimulus from external wake-up device 110.

FIG. 2B is a schematic illustration of wireless communication system 220 in accordance with some embodiments of the disclosed subject matter. In some embodiments, communication system 220 can include a processor 232, memory 234, and a transceiver and associated antenna 236. In some embodiments, processor 232 can be any suitable hardware processor or combination of processors, such as a CPU, a GPU, an ASIC, an FPGA, etc.

In some embodiments, memory 234 can include any suitable storage device or devices that can be used to store instructions, values, etc., that can be used, for example, by processor 232 to control operation of communication system 220, to communicate with one or more devices (e.g., computing device 104) and/or components of power tool 102 (e.g., controller 202, switch 224, etc.), etc. Memory 234 can include any suitable volatile memory, non-volatile memory, storage, or any suitable combination thereof. For example, memory 234 can include RAM, ROM, EEPROM, one or more flash drives, etc. In some embodiments, memory 234 can have encoded thereon a program for controlling operation of communication system 220. In such embodiments, processor 232 can execute at least a portion of the program to establish a wireless communication link with a computing device (e.g., computing device 104), provide power to controller 202 (e.g., via switch 224), receive data from computing device 104, provide data to controller 202, receive data from controller 202, transmit data to computing device 104, etc.

In some embodiments, transceiver and antenna 236 can include a transceiver and antenna configured to transmit and/or receive data using any suitable communication protocol(s). For example, transceiver and antenna 236 can include a transceiver and antenna configured to communicate using protocols associated with Bluetooth. As another example, transceiver and antenna 236 can include a transceiver and antenna configured to communicate using protocols associated with Wi-Fi. As yet another example, transceiver and antenna 236 can include a transceiver and antenna configured to communicate using protocols associated with NFC. As still another example, transceiver and antenna 236 can include a transceiver and antenna configured to communicate using protocols associated with Zigbee. As a further example, transceiver and antenna 236 can include a transceiver and antenna configured to communicate using protocols associated with UWB. Additionally or alternatively, in some embodiments, a light source (e.g., a laser, a light emitting diode, a laser diode, etc.) and a sensor (e.g., an image sensor) can be used to communicate with computing device. In some embodiments, communication system 220 can communicate using multiple different protocols and/or technologies. Additionally, in some embodiments, power tool 102 can include multiple communication systems 220 that may communicate using different communication protocols and/or technologies.

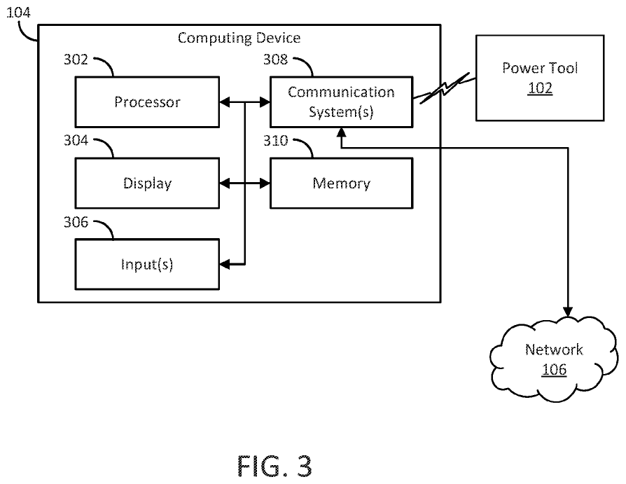

FIG. 3 is a schematic illustration of a computing device 104 implemented with a wireless communication system in accordance with some embodiments of the disclosed subject matter. As shown in FIG. 3, in some embodiments, computing device 110 can include a processor 302, a display 304, one or more inputs 306, one or more communication systems 308, and/or memory 310. In some embodiments, processor 302 can be any suitable hardware processor or combination of processors, such as a CPU, a GPU, an ASIC, an FPGA, etc. In some embodiments, display 304 can include any suitable display devices, such as a computer monitor, a touchscreen, a television, etc. In some embodiments, inputs 306 can include any suitable input devices and/or sensors that can be used to receive user input, such as a key board, a mouse, a touchscreen, a microphone, etc.

In some embodiments, communication systems 308 can include any suitable hardware, firmware, and/or software for communicating information over communication network 108 and/or any other suitable communication networks. For example, communication systems 308 can include one or more transceivers, one or more communication chips and/or chip sets, etc. In a more particular example, communication systems 308 can include hardware, firmware and/or software that can be used to establish Bluetooth connection, a Wi-Fi connection, a cellular connection, an NFC connection, an RFID connection, a UWB connection, an Ethernet connection, etc. When the communication system 308 implements wireless communicates (e.g., with power tool 102), computing device 104 may be also be referred to as a wireless computing device 104 (or a wireless external device 104).

In some embodiments, memory 310 can include any suitable storage device or devices that can be used to store instructions, values, etc., that can be used, for example, by processor 302 to present content using display 304, to communicate with one or more power tools 102 via communication system(s) 308, to communicate with server 106 via communication system(s) 308, etc. Memory 310 can include any suitable volatile memory, non-volatile memory, storage, or any suitable combination thereof. For example, memory 310 can include RAM, ROM, EEPROM, one or more flash drives, one or more hard disks, one or more solid state drives, one or more optical drives, etc. In some embodiments, memory 310 can have encoded thereon a computer program for controlling operation of computing device 104. In such embodiments, processor 302 can execute at least a portion of the computer program to establish a wireless communication link with another device (e.g., power tool 102), transmit data (e.g., information and/or instructions) to power tool 102, receive data from power tool 102, transmit data to server 106, receive data from server 106, etc.

FIG. 4A is a schematic illustration of electrical connections among a main power source, an alternate power source, a communication system, a wake-up sensor, and a controller of a tool in accordance with some embodiments of the disclosed subject matter. As shown in FIG. 4A, in some embodiments, communication system 220 can communicate with controller 202 via a bus or multiple connections 402. If main power source 216 is not connected and/or is not able to supply power to controller 202 and communication system 220 (e.g., via power line 212), communication system 220 can cause switch 224 to connect alternate power source 218 to controller 202 via second power line 222. More particularly, second power line 222 may include a first wire 222a and a second wire 222b. First wire 222a couples a first terminal 225a of switch 224 to alternate power source 218. Second wire 222b couples a second terminal 225b of switch 224 to controller 202. Switch 224 may also include a gate terminal 226 coupled to a control wire 227 from communication system 220 to receive a control signal (to open or close switch 224). In some examples, the wake-up sensor 250 may be coupled to the communication system 220. However, as noted above, in some embodiments, the power tool 102 does not include the wake-up sensor 250. Although the power line 212 is shown as passing through the controller 202 on route to the communication system 220, in some examples, the power line 212 has independent or shared connections with both the controller 202 and the communication system 220) (e.g., as shown in FIG. 2).

FIG. 4B is another schematic illustration of electrical connections among a main power source, an alternate power source, a communication system, a wake-up sensor, and a controller of a tool in accordance with some embodiments of the disclosed subject matter. As shown in FIG. 4B, in some embodiments, second power line 222 can be electrically coupled to power line 212, such that power can be supplied from alternate power source 218 to controller 202 via the same line used to provide main power. In some embodiments, alternate power source 218 can be coupled to power line 212 via switch 224 and a diode 404, which can inhibit power from main power source 216 from being provided to alternate power source 218 (e.g., to avoid damaging alternate power source 218). More particularly, second power line 222 may include first wire 222a and second wire 222b. First wire 222a couples a first terminal 225a of switch 224 to alternate power source 218. Second wire 222b couples a second terminal 225b of switch 224 to controller 202 via diode 404. For example, second wire 222b is coupled between second terminal 225b and an anode 228 of diode 404, and a cathode 229 of diode 404 is coupled to a portion of power line 212 (a third wire), which provides a connection to controller 202. Like FIG. 4A, switch 224 may also include gate terminal 226 coupled to control wire 227 from communication system 220 to receive a control signal (to open or close switch 224).

In some examples, the wake-up sensor 250 may be coupled to the communication system 220. However, as noted above, in some embodiments, the power tool 102 does not include the wake-up sensor 250. Although the power line 212 is shown as passing through the controller 202 on route to the communication system 220, in some examples, the power line 212 has independent or shared connections with both the controller 202 and the communication system 220) (e.g., as shown in FIG. 2).

FIG. 5 is a flowchart of a process 500 for wirelessly enabling alternate power in a power tool and/or for adjusting a security state of a power tool in the absence of a main power source, in accordance with some embodiments of the disclosed subject matter. Process 500 is described below as being carried out by a power tool 102 in the context of system 100. However, in some embodiments, the process 500 can be implemented by any other suitable device or system having additional, fewer, and/or alternative components. Additionally, although the blocks of the process 500 are illustrated in a particular order, in some embodiments, one or more of the blocks can be executed partially or entirely in parallel, can be executed in a different order than illustrated in FIG. 5, or can be bypassed or otherwise omitted. For example, in some embodiments, blocks 510-518 are bypassed or omitted.

At block 502, power tool 102 (e.g., via communication system 220) can establish a wireless link with an external device (e.g., computing device 104). In some embodiments, the wireless communication link established at 502 can be a relatively short-range wireless communication link (e.g., a link of under 50 feet, 30 feet, 25 feet, 15 feet, 5 feet, 1 foot, six inches, etc.). For example, the link can be a Bluetooth link. As another example, the link can be a Bluetooth Low Energy (BLE) link. As yet another example, the link can be an NFC link. As still another example, the link can be a Wi-Fi link. As a further example, the link can be a UWB link.

In some embodiments, communication system 220 can use any suitable technique or combination of techniques to establish the link. For example, computing device 104 can transmit a message requesting that devices within range respond with identifying information. In such an example, communication system 220 can respond to the message (e.g., with the requested identifying information of the communication device 110), and a wireless connection can be established. In some embodiments, communication system 220 can be powered by main power source 216 and/or alternate power source 218 when establishing a connection.

At block 504, power tool 102 (e.g., via communication system 220) can receive a signal from the external device that indicates that communication to and/or from controller 202 is to be carried out. In some embodiments, the signal can include an explicit instruction indicating that power is to be supplied to controller 202. For example, if power tool 102 is in a low power state, regardless of whether main power source 216 is capable of providing power to controller 202, power to controller 202 may be inhibited from main power source 216 and/or alternate power source 218 (e.g., via switch 224 interrupting a connection between alternate power source 218 and controller 202). In such an example, communication system 220) can indicate the power state to the computing device 104, which may provide an explicit instruction to provide power to controller 202 (e.g., initiated with or without user intervention). As another example, if main power source 216 is disconnected and/or otherwise incapable of providing power to communication system 220 and controller 202, communication system 220 can indicate the power state to the computing device 104, which may provide an explicit instruction to provide power to controller 202 (e.g., initiated with or without user intervention).

Additionally or alternatively, in some embodiments, the signal can include an implicit indication that power is to be supplied to controller 202. For example, computing device 104 can transmit an instruction directed to controller 202, and communication system 220) can determine that the instruction for controller 202 is an indication that power is to be provided to controller 202. As another example, computing device 104 can establish an active communication link with communication system 220, and communication system 220 can determine that the active communication link is an indication that power is to be provided to controller 202. For example, the communication system 220 may have a predefined condition (e.g., defined in memory 234) that causes the processor 232 to equate an active communication link with a computing device 104 with an indication that power is to be provided to controller 202.

At block 506, the communication system 220 determines whether power is to be provided to controller 202. This determination may be based on (e.g., responsive to) the signal received in block 504 indicating that communication with the controller is to be carried out. This determination may be further conditioned on other factors, such as whether the main power source 216 is present and above a minimum charge threshold. At block 506, when communication system 220 determines that power is to be provided to controller 202 from alternate power source 218 (“YES” at block 506), communication system 220 can move to block 508. Otherwise, when communication system 220 determines that power is not to be provided to controller 202 from alternate power source 218 (“NO” at block 506), communication system 220 can move to block 510. In some embodiments, when power is provided to controller 202 by main power source 216, communication system 220 can determine at block 506 that powering controller 202 from alternate source 218 is not needed.

At block 508, communication system 220 can cause a switch (e.g., switch 224) to provide power from alternate power source 218 to controller 202. For example, communication system 220) can cause switch 224 to complete a circuit between alternate power source 218 and controller 202. For example, communication system 220 (e.g., processor 232) can output a control signal to switch 224 to selectively close (e.g., turn on) or open (e.g., turn off) switch 224.

In some embodiments, process 500 ends after block 508. In some embodiments, process 500 proceeds with one or more optional blocks 509.

In embodiments in which the process 500 proceeds, at block 510, communication system 220 and/or controller 202 (e.g., via communication system 220) can communicate any suitable data with computing device 104. For example, power tool 102 can communicate information to computing device 104 and/or receive information from computing device 104. In a more particular example, power tool 102 can communicate to computing device 104 one or more of status information (e.g., including a security status) associated with power tool 102, operation data (e.g., operation statistics) associated with power tool 102, identification information associated with power tool 102, power tool usage information associated with power tool 102, power tool maintenance data associated with power tool 102, etc. As another example, power tool 102 can receive from computing device 104 information that can facilitate additional functionality and/or services associated with power tool 102 (e.g., enabling one or more features and/or services), that can provide updated software (e.g., an updated application to computing device 104, updated software and/or firmware for power tool 102, etc.), and/or any other suitable functions.

At block 512, power tool 102 (e.g., via communication system 220) and/or controller 202) can determine whether an instruction to alter a security state of power tool 102 has been received from computing device 104 (e.g., as part of the communication in block 510). If communication system 220 receives an instruction to alter a security state of power tool 102 and/or determines that an instruction to alter a security state of power tool 102 has been received (“YES” at block 512), communication system 220 can move to block 514. In some embodiments, an instruction to alter a security state of power tool 102 can be a signal received at block 504, which can cause communication system 220 to provide power to controller 202 from alternate power source 218 (e.g., via switch 224). Otherwise, communication system 220) can move to block 516.

In some embodiments, the instruction to alter the security state of the tool can include any suitable instruction or combination of instructions. For example, the instruction can include an unlock instruction to unlock operation of the power tool, a lock instruction to lock operation of the power tool, or an alter authorized users instruction. A lock instruction can include an instruction to lock the power tool to inhibit use of the power tool. As another example, a lock instruction can include an instruction to lock the power tool after a predetermined amount of time has elapsed and/or at a predetermined time. An unlock instruction can include an instruction to unlock the power tool. As another example, an unlock instruction can include an instruction to unlock the power tool after a predetermined amount of time has elapsed and/or at a predetermined time. An alter authorized users instruction can include an instruction to alter authorized users of the tool, for example, by adding or removing a user that is permitted to use the power tool and/or alter security settings associated with the power tool. A memory of the power tool (e.g., memory 206) may maintain a list or table of authorized users (e.g., each identified by a name or identification number and potentially associated with a password or other verification feature). According, the alter authorized users instruction may cause processor 204 to update the list or table of authorized users maintained on memory 206.

At block 514, communication system 220 can provide the instruction to alter the security state of the power tool to controller 202, and controller 202 can alter the security state of the tool. For example, controller 202 can lock the power tool (e.g., using software and/or hardware, such as by altering a setting disabling the power tool from engaging the motor, by opening a switch that provides power to the motor or a motor controller, by mechanically locking a part of the tool such as a trigger, etc.). As another example, controller 202 can unlock the power tool (e.g., using software and/or hardware, such as by altering a setting enabling the power tool to engage the motor, by closing a switch that provides power or enables power to be provided to the motor or a motor controller, by mechanically unlocking a part of the tool such as a trigger, etc.). As yet another example, controller 202 can update information designating authorized users (e.g., storing information associated with an authorized user in memory).

In some embodiments, in block 514, when the controller 202 receives the instruction to alter the security state of power tool 102 from a computing device 104 via the communication system 220, the controller 202 may determine whether the instruction is authentic. For example, the instruction may include a passcode, which the controller 202 may analyze to verify the authenticity of the instruction. For example, the controller 202 may compare the passcode to one or more pre-stored passcodes in memory 206. In the case of a match, the controller 202 may verify that the instruction is authentic and proceed to alter the security state of tool 102. In the case of the passcode not matching a pre-stored passcode, the controller 202 may ignore the instruction and not alter the security state. As another example, the passcode may be encrypted (e.g., with a public key). In such an example, the controller 202 may decrypt the passcode with a private key, and then compare the passcode to one or more pre-stored passcodes in memory 206. In the case of a match, the controller 202 may verify that the instruction is authentic and proceed to alter the security state of tool 102. In some embodiments, other authentication techniques are used by the controller 202 to verify that an instruction received from computing device 104 via communication system 220 is authentic before the controller 202 alters the security state of power tool 102. In the case of the passcode not matching a pre-stored passcode, the controller 202 may ignore the instruction and not alter the security state

At block 516, communication system 220 can determine whether a condition has been satisfied indicating that power to controller 202 from alternate power source 218 is to be inhibited. For example, communication system 220 can determine whether a predetermined amount of time has passed since a most recent communication to or from controller 202. As another example, communication system 220 can determine whether the communication link established at 502 has been terminated.

If communication system 220 determines that a condition for inhibiting power to controller 202 has not been satisfied (“NO” at block 516), communication system 220 can return to block 510 to continue potentially communicating with computing device 104. Otherwise, if communication system 220 determines that a condition for inhibiting power to controller 202 has been satisfied (“YES” at block 516), communication system 220 can move to block 518.

At block 518, communication system 220 can cease communications to controller 202 and/or cause switch 224 to stop power from being provided to controller 202 from alternate power source 218 (e.g., by sending a control signal to cause switch 224 to open to create a gap in a circuit between alternate power source 218 and controller 202).

FIG. 6 is a flowchart of a process 600 for wirelessly enabling alternate power in a power tool and/or for unlocking the power tool in the absence of a main power source via a wake-up sensor, in accordance with some embodiments of the disclosed subject matter. Process 600 is described below as being carried out by system 100. However, in some embodiments, the process 600 can be implemented by any other suitable system having additional, fewer, and/or alternative components. Additionally, although the blocks of the process 600 are illustrated in a particular order, in some embodiments, one or more of the blocks can be executed partially or entirely in parallel, can be executed in a different order than illustrated in FIG. 6, or can be bypassed or otherwise omitted.

At block 602, power tool 102 (e.g., via wake-up sensor 250) can receive a stimulus from an external identification tag reader (e.g., external wake-up device 110). In some embodiments, the stimulus received can wirelessly induce an electric current in wake-up sensor 250. For example, the external identification tag reader 110 can comprise an NFC tag reader, and the wake-up sensor 250 can comprise an NFC tag in which a current can be induced in response to an electromagnetic signal from the NFC tag reader. As another example, the external identification tag reader 110 can comprise an RFID tag reader, and the wake-up sensor 250 can comprise an RFID tag in which a current can be induced in response to an electromagnetic signal from the RFID tag reader. Wake-up sensor 250 can be configured to respond to a signal that is unique to power tool 102 so that current is induced in wake-up sensor 250 when the signal unique to power tool 102 is received, but not when another signal is received (e.g., a signal that is unique to another power tool). For example, the unique signal may encode an identifier for power tool 102 or another encoded value that is specific to power tool 102. In other examples, the stimulus provided to the wake-up sensor 250 is unique to a set or power tools that includes power tool 102, or is not unique to a particular set of power tools and, rather, is broadly applicable to power tools including wake-up sensor 250.

In some examples, the wake-up sensor 250 includes an antenna and a processing circuit (e.g., a microchip). The wake-up sensor 250 may be a passive device (e.g., a passive tag) with a processing circuit that includes an energy harvesting circuit configured to harvest wireless energy from the wake-up device 110. For example, the wake-up device 110 may generate a stimulus (wireless signal) that induces current in the antenna of the wake-up sensor 250, which is harvested by the processing circuit (e.g., by an inductor and capacitor (LC circuit) of the processing circuit). The capacitor may then power the other circuitry of the processing circuit with the harvested energy. In some examples, in addition to providing the wireless energy, the stimulus (wireless signal) may optionally also include the aforementioned unique signal encoding an identifier or value for the particular power tool 102 or set of tools including the particular power tool 102. In some examples, the wake-up sensor 250 includes an energy harvesting circuit tuned or configured (e.g., with an LC circuit having a particular resonance) such that the processing circuit of the wake-up sensor 250 is configured to harvest energy from a stimulus having particular characteristics (e.g., frequency, amplitude, etc.). Accordingly, the successful harvesting of energy sufficient to power the processing circuit indicates that the wake-up device 110 provided a stimulus having certain characteristics particularly corresponding to the wake-up sensor 250, and may serve to validate or verify that the wake-up device 110 and is an authorized device.

At block 604, wake-up sensor 250) can issue a wake-up signal to the communication system 220. For example, wake-up sensor 250 can be electrically coupled to communication system 220 (e.g., via a wired connection), and the wake-up signal includes an electronic signal that the wake-up sensor 250 provides in response to the stimulus at block 602. For example, the wake-up sensor 250 (e.g., its processing circuit) may provide the wake-up signal as an automatic response to being powered on (e.g., by energy harvested from current induced in the wake-up sensor 250 by the stimulus of the wake-up device 110). As another example, the wake-up sensor 250 (e.g., its processing circuit) may provide the wake-up signal in response to being powered on (e.g., by energy harvested) and conditioned on determining that a unique signal received as part of the stimulus matches a pre-stored signal of the wake-up sensor 250 (e.g., stored in a memory of the processing circuit of the wake-up sensor). In some examples, the electronic signal is a voltage signal at a particular voltage (e.g., 0 volts, 3 volts, 5 volts) provided to a pin or other input of the communication system 220. In some examples, the electronic signal is an encoded signal or instruction provided to an input the communication system 220.

At block 606, communication system 220 can awaken from a low power state upon receiving the wake-up signal from wake-up sensor 250. For example, responsive to the wake-up signal from the wake-up sensor 250, the communication system 220 is transitioned from the low power state (also referred to as a deep sleep state) to an active state to allow wireless communication (e.g., with the computing device 104). For example, the communication system 220, when awakened into the active state, may begin advertising or beaconing, enabling the computing device 104 to form a wireless communication link with the communication system 220) (described further below). In some examples, the wake-up signal serves as an interrupt signal to a processor of the communication system 220 (e.g., a 3 or 5 volt signal at an interrupt pin of the processor), which causes the processor to exit a standby software code loop (of the deep sleep state) and to jump to main software code loop (of the woken or active state). In a low power state, the average power consumed by the communication system 220 is lower than when in an active state. For example, because the communication system 220 executes fewer instructions (e.g., per second), performs fewer functions, transmits fewer (or no) wireless communications, and/or receives fewer (or no) wireless communications. In this example, the communication system 220 may be powered by the alternate power source 218 during blocks 604 (e.g., when the main power source 216 is depleted or disconnected from the main power source interface 214).

At block 608, communication system 220 can cause a switch (e.g., switch 224) to provide power from alternate power source 218 to controller 202. For example, in response to receiving the wake-up signal, communication system 220 can output a control signal to switch 224, thereby causing switch 224 to close to complete a circuit between alternate power source 218 and controller 202.

At block 610, power tool 102 (e.g., via communication system 220) can establish a wireless link with an external device (e.g., computing device 104). In some embodiments, the wireless communication link established at 610 can be a relatively short-range wireless communication link. For example, the link can be a Bluetooth link. As another example, the link can be a Bluetooth Low Energy (BLE) link. As yet another example, the link can be an NFC link. As still another example, the link can be a Wi-Fi link. As a further example, the link can be a UWB link. For example, the link may be a communication link of under 50 feet, 30 feet, 25 feet, 15 feet, 5 feet, 1 foot, under 6 inches, or the like.

In some embodiments, the stimulus from the wake-up device 110 to the wake-up sensor 250 in block 602 is provided wirelessly, out-of-band (e.g., using a different communication protocol), with respect to the wireless communication between the computing device 104 and the communication system 220. Accordingly, a lower-power wireless communication protocol or platform may be used to trigger the wake-up via wake-up sensor 250 than the wireless communication protocol or platform used by the communication system 220 to wirelessly communicate with the computing device 104. Thus, power of the alternate power source 218 may be conserved, extending the life of the alternate power source 218, relative to an embodiment in which the alternate power source 218 powers communication system 220 in an active state for extended periods of time (e.g., during shipping, while on a store shelf, etc.).

In some embodiments, communication system 220 can use any suitable technique or combination of techniques to establish the link. For example, computing device 104 can transmit a message requesting that devices within range respond with identifying information. In such examples, communication system 220 can respond to the message (e.g., with the requested identifying information of the communication device 110), and a wireless connection can be established using the identifying information. In some examples, the communication system 220 of power tool 102 may periodically beacon or advertise identifying information, which the computing device 104 may receive. The computing device 104 may the use the identifying information to establish a wireless connection with the communication system 220. The communication system 220 can be powered by alternate power source 218 when establishing the connection. In some embodiments, when main power source 216 is present and connected to main power source interface 216, the communication system 220 can be powered by main power source 216 when establishing the connection.

At block 612, communication system 220 can receive a signal (e.g., an unlock instruction) from the external computing device 104. In some embodiments, that signal can include an explicit unlock instruction indicating that power is to be supplied to electronic components 210 of power tool 102. For example, if power tool 102 is in a locked state, regardless of whether main power source 216 is capable of providing power to electronic components 210, power to electronic components 210 may be inhibited from main power source 216 and/or alternate power source 218. For example, controller 202 may ignore user inputs or requests for operation (e.g., trigger pulls or button presses) when in a locked state by, in contrast to an unlocked state, not responding with powering or operating electric components 210 (e.g., a motor, LEDs, etc.). In the example of an unlocking instructions, computing device 104, may provide an explicit instruction to unlock power tool 102 to request that power be provided to (or operation of) electronic components 210 (e.g., in response to future user inputs or requests). In some embodiments, communication device 220 can issue an instruction (e.g., the unlock instruction or a decoded version thereof) to controller 202 in response to unlock instruction from computing device 104.

At block 614, in response to the unlock instruction of block 612, the controller 202 can unlock the device. In some embodiments, unlocking the device entails enabling power from main power source 216 and/or alternate power source 218 to be provided to electronic components 210 (e.g., in response to a future user input or request at power tool 102, such as a trigger pull or button press of power tool 102). In some embodiments, controller 202 can unlock the power tool using software and/or hardware, such as by altering a setting enabling the power tool to engage the motor, by closing a switch that provides power or enables power to be provided to the motor or a motor controller, by mechanically unlocking a part of the tool such as a trigger, and/or the like.

In some examples, when the controller 202 receives the unlock instruction from computing device 104 via the communication system 220 in block 612, the controller 202 may determine whether the instruction is authentic before unlocking power tool 102 in block 614. For example, the instruction may include a passcode, which the controller 202 may analyze to verify the authenticity of the instruction. For example, the controller 202 may compare the passcode to one or more pre-stored passcodes in memory 206. In the case of a match, the controller 202 may verify that the instruction is authentic and proceed to unlock power tool 102. In the case of the passcode not matching a pre-stored passcode, the controller 202 may ignore the instruction and not unlock power tool 102. As another example, the passcode may be encrypted (e.g., with a public key). In such an example, the controller 202 may decrypt the passcode with a private key, and then compare the passcode to one or more pre-stored passcodes in memory 206. In the case of a match, the controller 202 may verify that the instruction is authentic and proceed to unlock power tool 102. In some embodiments, other authentication techniques are used by the controller 202 to verify that an instruction received from computing device 104 via communication system 220 is authentic before the controller 202 unlocks power tool 102. In the case of the passcode not matching a pre-stored passcode, the controller 202 may ignore the instruction and unlock power tool 102

Although block 608 is illustrated as preceding block 610 in FIG. 6, in some examples, block 608 occurs after block 610, or occurs in parallel with block 610. In some examples, execution of block 608 (e.g., closing switch 224) by the communication system 220 is conditioned on a wireless connection being established in block 610. In other words, in some examples, communication system 220 may close switch 224 in response to the wireless connection being established in block 610.

In some examples, before execution of process 600 or after execution of block 614 of process 600, the process 500 of FIG. 5 may be executed to cause the tool to enter (or re-enter) a locked state (e.g., in the case where a lock instruction is received in block 510, as described with respect to blocks 509).

It is to be understood that the disclosure is not limited in its application to the details of construction and the arrangement of components set forth in the description provided herein or illustrated in the associated drawings. The disclosure is capable of other embodiments and of being practiced or of being carried out in various ways. Also, it is to be understood that the phraseology and terminology used herein is for the purpose of description and should not be regarded as limiting. The use of “including.” “comprising.” or “having” and variations thereof herein is meant to encompass the items listed thereafter and equivalents thereof as well as additional items. Unless specified or limited otherwise, the terms “mounted.” “connected,” “supported,” and “coupled” and variations thereof are used broadly and encompass both direct and indirect mountings, connections, supports, and couplings. Further, “connected” and “coupled” are not restricted to physical or mechanical connections or couplings.

As used herein, unless otherwise limited or defined, discussion of particular directions is provided by example only, with regard to particular embodiments or relevant illustrations. For example, discussion of “top,” “front,” or “back” features is generally intended as a description only of the orientation of such features relative to a reference frame of a particular example or illustration. Correspondingly, for example, a “top” feature may sometimes be disposed below a “bottom” feature (and so on), in some arrangements or embodiments. Further, references to particular rotational or other movements (e.g., counterclockwise rotation) is generally intended as a description only of movement relative a reference frame of a particular example of illustration.

In some embodiments, including computerized implementations of methods according to the disclosure, can be implemented as a system, method, apparatus, or article of manufacture using standard programming or engineering techniques to produce software, firmware, hardware, or any combination thereof to control a processor device (e.g., a serial or parallel processor chip, a single- or multi-core chip, a microprocessor, a field programmable gate array, any variety of combinations of a control unit, arithmetic logic unit, and processor register, etc.), a computer (e.g., a processor device operatively coupled to a memory), or another electronically operated controller to implement aspects detailed herein. Accordingly, for example, embodiments of the disclosure can be implemented as a set of instructions, tangibly embodied on a non-transitory computer-readable media, such that a processor device can implement the instructions based upon reading the instructions from the computer-readable media. Some embodiments of the disclosure can include (or utilize) a control device such as an automation device, a computer including various computer hardware, software, firmware, etc., consistent with the discussion below: As specific examples, a control device can include a processor, a microcontroller, a field-programmable gate array, a programmable logic controller, logic gates etc., and other typical components that are known in the art for implementation of appropriate functionality (e.g., memory, communication systems, power sources, user interfaces and other inputs, etc.). Also, functions performed by multiple components may be consolidated and performed by a single component. Similarly, the functions described herein as being performed by one component may be performed by multiple components in a distributed manner. Additionally, a component described as performing particular functionality may also perform additional functionality not described herein. For example, a device or structure that is “configured” in a certain way is configured in at least that way, but may also be configured in ways that are not listed.

The term “article of manufacture” as used herein is intended to encompass a computer program accessible from any computer-readable device, carrier (e.g., non-transitory signals), or media (e.g., non-transitory media). For example, computer-readable media can include but are not limited to magnetic storage devices (e.g., hard disk, floppy disk, magnetic strips, etc.), optical disks (e.g., compact disk (CD), digital versatile disk (DVD), etc.), smart cards, flash memory devices (e.g., card, stick, etc.), and other solid state memory (e.g., RAM, ROM, EEPROM, etc.). Additionally it should be appreciated that a carrier wave can be employed to carry computer-readable electronic data such as those used in transmitting and receiving electronic mail or in accessing a network such as the Internet or a local area network (LAN). Those skilled in the art will recognize that many modifications may be made to these configurations without departing from the scope or spirit of the claimed subject matter.

Certain operations of methods according to the disclosure, or of systems executing those methods, may be represented schematically in the figures or otherwise discussed herein. Unless otherwise specified or limited, representation in the figures of particular operations in particular spatial order may not necessarily require those operations to be executed in a particular sequence corresponding to the particular spatial order. Correspondingly, certain operations represented in the figures, or otherwise disclosed herein, can be executed in different orders than are expressly illustrated or described, as appropriate for particular embodiments of the disclosure. Further, in some embodiments, certain operations can be executed in parallel, including by dedicated parallel processing devices, or separate computing devices configured to interoperate as part of a large system.

As used herein in the context of computer implementation, unless otherwise specified or limited, the terms “component,” “system,” “module,” and the like are intended to encompass part or all of computer-related systems that include hardware, software, firmware, a combination of hardware and software/firmware, software, or firmware, in execution. For example, a component may be, but is not limited to being, a processor device, a process being executed (or executable) by a processor device, an object, an executable, a thread of execution, a computer program, or a computer. By way of illustration, both an application running on a computing device and the computing device can be a component. One or more components (or system, module, etc.) may reside within a process or thread of execution, may be localized on one computing devices, may be distributed between two or more computing devices or other processor devices, or may be included within another component (or system, module, etc.).

In some implementations, devices or systems disclosed herein can be utilized or installed using methods embodying aspects of the disclosure. Correspondingly, description herein of particular features, capabilities, or intended purposes of a device or system is generally intended to inherently include disclosure of a method of using such features for the intended purposes, a method of implementing such capabilities, and a method of installing disclosed (or otherwise known) components to support these purposes or capabilities. Similarly, unless otherwise indicated or limited, discussion herein of any method of manufacturing or using a particular device or system, including installing the device or system, is intended to inherently include disclosure, as embodiments of the disclosure, of the utilized features and implemented capabilities of such device or system.

As used herein, unless otherwise defined or limited, ordinal numbers are used herein for convenience of reference based generally on the order in which particular components are presented for the relevant part of the disclosure. In this regard, for example, designations such as “first,” “second,” etc., generally indicate only the order in which the relevant component is introduced for discussion and generally do not indicate or require a particular spatial arrangement, functional or structural primacy or order.

As used herein, unless otherwise defined or limited, directional terms are used for convenience of reference for discussion of particular figures or examples. For example, references to downward (or other) directions or top (or other) positions may be used to discuss aspects of a particular example or figure, but do not necessarily require similar orientation or geometry in all installations or configurations.

As used herein, unless otherwise defined or limited, the phase “and/or” used with two or more items is intended to cover the items individually and the items together. For example, a device having “a and/or b” is intended to cover: a device having a (but not b); a device having b (but not a); and a device having both a and b.

This description is presented to enable a person skilled in the art to make and use embodiments of the disclosure. Various modifications to the illustrated examples will be readily apparent to those skilled in the art, and the generic principles herein can be applied to other examples and applications without departing from the principles disclosed herein. Thus, embodiments of the disclosure are not intended to be limited to embodiments shown and described herein, but are to be accorded the widest scope consistent with the principles and features disclosed herein and the claims below. The preceding detailed description is to be read with reference to the figures, in which like elements in different figures have like reference numerals. The figures, which are not necessarily to scale, depict selected examples and are not intended to limit the scope of the disclosure. Skilled artisans will recognize the examples provided herein have many useful alternatives and fall within the scope of the disclosure.

Various features and advantages of the disclosure are set forth in the following claims.

1. A system for wirelessly enabling alternate power in a power tool, the system comprising:
a power source interface configured to selectively receive a battery pack;
an alternate power source;
a controller electrically coupled to the power source interface, and electrically coupled to the alternate power source via a switch; and
a communication system electrically coupled to the alternate power source and the power source interface, and operatively coupled to the switch, wherein the communication system comprises a wireless transceiver and a processor, wherein the processor is configured to:
establish a wireless connection with an external device;
receive a signal from the external device; and
in response to the signal, cause the switch to complete a circuit between the alternate power source and the controller.

2. The system of claim 1, wherein the communication system comprises at least one selected from the group of a Bluetooth communication system and a Bluetooth Low Energy communication system.

3. The system of claim 1, wherein the system is incorporated into the power tool.

4. The system of claim 1, wherein the controller is configured to:
receive, from the external device via the communication system, an instruction to alter a security state of the power tool.

5. The system of claim 4, wherein the controller is configured to:
in response to the instruction to alter the security state of the power tool, cause operation of the power tool to be inhibited.

6. The system of claim 5, wherein the controller is configured to:
inhibit operation of the power tool by locking operation of the power tool.

7. The system of claim 4, wherein the controller is configured to:
in response to the instruction to alter the security state of the power tool, unlock operation of the power tool.

8. The system of claim 1, wherein the switch comprises a transistor.

9. The system of claim 1, further comprising:
a first wire configured to electrically couple a first terminal of the switch to the alternate power source; and
a second wire configured to electrically couple a second terminal of the switch to the controller.

10. The system of claim 9, further comprising:
a third wire configured to electrically couple the communication system to the power source interface; and
a diode having an anode and a cathode, wherein the anode is electrically coupled to the second wire, and the cathode is electrically coupled to the third wire.

11. A method for wirelessly enabling alternate power in a power tool, comprising:
establishing, via a communication system, a wireless connection with an external device;
receiving a signal from the external device; and
in response to the signal, causing a switch to complete a circuit between an alternate power source and a controller, wherein the controller is electrically coupled to a power source interface configured to selectively receive a battery pack, and electrically coupled to the alternate power source via the switch.

12. The method of claim 11, wherein the communication system comprises at least one selected from a group of a Bluetooth communication system and a Bluetooth Low Energy communication system.

13. The method of claim 11, wherein the communication system is incorporated into the power tool.

14. The method of claim 11, further comprising:
receiving, from the external device via the communication system, an instruction to alter a security state of the power tool.

15. The method of claim 14, further comprising:
in response to the instruction to alter the security state of the power tool, causing operation of the power tool to be inhibited.

16. The method of claim 15, further comprising:
inhibiting operation of the power tool by locking operation of the power tool.

17. The method of claim 14, further comprising:
in response to the instruction to alter the security state of the power tool, unlocking operation of the power tool.

18. The method of claim 11, wherein the switch comprises a gate terminal, and wherein, to cause the switch to complete the circuit between the alternate power source and the controller, the communication system provides a control signal to the gate terminal.

19.-32. (canceled)
